(19) United States
(12) Patent Application Publication
(10) Pub. No.: US 2026/0211622 A1
(43) Pub. Date: Jul. 23, 2026

(54) CONTROLLABLE AND/OR SELF-CONTROLLING OBJECT COMPRISING A QUANTUM RANDOM NUMBER GENERATOR

(71) Applicant: ELMOS Semiconductor SE, Leverkusen (DE)

(72) Inventors: Olaf Hug, Berlin (DE); Thomas Rotter, Neunkirchen am Brand (DE); Julia Koelbel, Dortmund (DE)

(73) Assignee: ELMOS Semiconductor SE, Leverkusen (DE)

(21) Appl. No.: 19/570,242

(22) Filed: Mar. 18, 2026

Related U.S. Application Data
(63) Continuation of application No. PCT/EP2024/076346, filed on Sep. 19, 2024.

(30) Foreign Application Priority Data
Sep. 20, 2023 (DE) 10 2023 125 543.6
Sep. 26, 2023 (DE) 10 2023 126 115.0
Sep. 26, 2023 (DE) 10 2023 126 167.3
Sep. 26, 2023 (EP) 23199793.3
Sep. 26, 2023 (LU) LU505175

(51) Int. Cl. G06F 7/58

(52) U.S. Cl. CPC G06F 7/582

(57) ABSTRACT

The disclosure relates to a controllable and/or self-controlling object comprising a monolithically integrated entropy source having: a photon source that is designed to emit photons, the photon source comprising a first outer shell, said first outer shell being formed by a first base surface, a first top surface, and at least one first side surface connecting the first base surface and the first top surface to one another; and a photon detector that is designed to detect the photons emitted by the photon source, the first base surface of the photon source being arranged so as to face the photon detector.

### CROSS REFERENCE TO RELATED APPLICATIONS

This application is a continuation application of international patent application PCT/EP2024/076346, filed on Sep. 19, 2024, and designating the U.S., which claims priority to German patent application 10 2023 125 543.6, filed on Sep. 20, 2023, German patent applications 10 2023 126 115.0 and 10 2023 126 167.3, filed on Sep. 26, 2023, European patent application 23 199 793.3, filed on Sep. 26, 2023 and Luxembourg patent application LU505175, filed on Sep. 26, 2023, each of which are hereby incorporated by reference in their entireties.

### TECHNICAL FIELD

The present disclosure relates, among other things, to a controllable and/or self-controlling object with a quantum random number generator with an entropy source.

### BACKGROUND

In many areas of science and technology, random events and the determination of probabilities play a particularly prominent role. For example, Monte Carlo simulations, individualization of transmitters and/or components, bus addressing methods and secure encryption methods rely heavily on the provision of random numbers. A general distinction is made between so-called pseudo-random numbers and true random numbers.

While pseudo-random numbers are generated using deterministic formulas by pseudo-random number generators (Pseudo Random Number Generators, PRNGs), meaning they are not absolutely random, non-deterministic random number generators (True Random Number Generators, TRNGs) for providing true random numbers are generally based on real unpredictable processes, such as thermal or atmospheric noise, and not on artificially generated patterns of deterministic algorithms. However, even the results of such non-deterministic random number generators based on external parameters can still tend slightly towards higher or even numbers due to weak correlations, depending on the underlying random element, thus enabling at least partial predictability of the random numbers generated in this way. Such true random number generators (TRNGs) can also be manipulated from the outside, for example in the case of thermal entropy sources for the random numbers, if their construction is inadequate.

In contrast, so-called quantum random number generators (QRNGs), as a special subgroup of TRNGs, are based on fundamental quantum processes for generating random numbers and are therefore, at least theoretically, not coupled to other external factors and effects influencing statistics. Therefore, they do not have a so-called side channel that allows influencing the generation process of the random numbers.

Quantum random number generators can be realized using random properties of photons (as photonic quantum random number generators). A conventional concept for generating random numbers is based on the use of random arrival times of photons on a photon detector. This distribution effect, based on an intrinsic photon statistics of the photons of an associated photon source that is not deterministically computable in principle, can be used to provide true random numbers. The arrival times of photons on a single-photon detector generally exhibit an exponential distribution.

EP 3 529 694 relates to a (quantum) random number generator comprising a photon source, one or more photon detectors configured to detect at least one photon belonging to a stream of detected photons generated by the photon source, and electronic scanning means functionally connected to the photon detectors and configured to implement a logical method for extracting a binary sequence based on the arrival time of each of the detected photons. In the random number generator, the photon source and the photon detectors are arranged side by side and integrated into a single semiconductor substrate.

WO 2016/016741 A1 relates to a (quantum) random number generator comprising a photon source and one or more SPAD-type photon detectors configured to detect a photon flux equal to λ, with the photons being generated by the photon source. The random number generator also comprises electronic scanning means. These electronic scanning means are configured to detect the arrival time t of a photon incident on each SPAD photon detector for each of the observation windows Tw, and they are also configured to convert the arrival time t into a binary sequence. The photon source and the electronic scanning means are configured such that the product λ*Tw is less than or equal to 0.01.

### SUMMARY

A controllable and/or self-controlling object is provided, the object comprises an action unit for producing a specific behavior of the object, a control unit to control the action unit in accordance with corresponding control information, a detector unit for detecting environmental influences acting on the object, a quantum random number generator, wherein the quantum random number generator includes a monolithically integrated entropy source, wherein the entropy source includes a photon source configured to emit photons, wherein the photon source includes an outer shell, wherein the outer shell is formed by a base surface, a top surface and at least one side surface connecting the base surface and the top surface, and a photon detector designed to detect the photons emitted by the photon source, wherein the base surface of the photon source is arranged facing the photon detector, wherein the base surface of the photon source is formed in a two-dimensional plane, wherein a normal vector perpendicular to the base surface is pointed in a direction of the photon detector, and an electronic circuit designed to generate a random bit depending on an output signal of the entropy source, wherein a characteristic of the output signal of the entropy source depends on a temporal frequency of the photons detected by the photon detector, and wherein the control unit is designed to control the action unit depending on the environmental influences detected by the detector unit and depending on the random bit.

### BRIEF DESCRIPTION OF THE DRAWINGS

In the drawings:

FIG. 1 shows a schematic representation of a BCD substrate provided by a method for providing low-lying p-n junctions in a BCD process and a TCAD representation of the resulting dopant distribution;

FIG. 2 shows a schematic representation of an exemplary first embodiment of an entropy source in a cross-sectional view;

FIG. 3 shows a schematic representation of an exemplary second embodiment of the entropy source in a cross-sectional view;

FIG. 4 shows a schematic representation of an exemplary third embodiment of the entropy source in a cross-sectional view;

FIG. 5 shows a graphical representation of the dependence of a) the SPAD current and b) the ratio between SPAD current and Zener current as a function of the Zener reverse voltage at different SPAD reverse voltages (less than, equal to, greater than the breakdown voltage) within the entropy source from FIGS. 2 to 4;

FIG. 6 shows a schematic representation of a quantum random generator with the entropy source from FIGS. 2 to 4;

FIG. 7 shows a schematic representation of an exemplary layout of an integrated electronic circuit with the entropy source from FIGS. 2 to 4 and/or the quantum random generator from FIG. 6 in a top view; and

FIG. 8 shows a controllable and/or self-controlling object with the quantum random number generator from FIG. 6.

### DESCRIPTION

An optional object of the present disclosure may be to specify a device and/or a method which is/are suitable to enrich the prior art.

One possible concrete object could be to specify an entropy source or a quantum random number generator that has a high degree of security. One possible concrete object could be to additionally or alternatively specify an entropy source or a quantum random number generator that uses a small area. One possible concrete object could be to additionally or alternatively specify an entropy source or a quantum random number generator that is adapted for use in a controllable and/or self-controlling object.

This object is achieved by the features of the respective independent claims. Optional further developments of the disclosed solution are specified in the dependent claims.

The object can be solved by a controllable and/or self-controlling object, wherein the object comprises action means for generating a specific behavior of the object, and control means for controlling the action means in accordance with appropriate control information, and detector means for detecting environmental influences acting on the object. The object comprises a quantum random number generator. The quantum random number generator comprises a monolithically integrated entropy source. The entropy source comprises to a photon source that is designed to emit photons, the photon source comprising a first outer shell, said first outer shell being formed by a first base surface, a first top surface, and at least one first side surface connecting the first base surface and the first top surface to one another; and a photon detector that is designed to detect the photons emitted by the photon source, the first base surface of the photon source being arranged so as to face the photon detector. The quantum random number generator comprises an electronic circuit designed to generate a random bit depending on an output signal of the entropy source, wherein a characteristic of the output signal of the entropy source depends on a temporal frequency of the photons detected by the photo detector, and wherein the control means are designed to control the action means depending on the environmental influences detected by the detector means and depending on the random bit.

The photon detector can comprise a second outer shell, wherein the second outer shell is formed by a second base surface, a second top surface, and at least one second side surface connecting the first base surface and the first top surface to one another. The first base surface of the photon source can be arranged facing the second base surface of the photon detector.

Additionally, or alternatively, the object is achieved by a monolithically integrated entropy source, optionally for a quantum random number generator, wherein the entropy source comprises a photon source configured to emit photons. The entropy source comprises a photon detector, which is designed to detect the photons emitted by the photon source. The photon detector comprises a second outer shell, wherein the second outer shell is formed by a second base surface, a second top surface, and at least one second side surface connecting the second base surface and the second top surface to one another. The second base surface of the photon detector is arranged facing the photon source.

This means that an entropy source can be provided that is implemented in one piece on a semiconductor substrate with a surface. It can be a vertical entropy source with at least one photon source and at least one photon detector. The surface of the semiconductor substrate can be defined as a horizontal plane with a first direction in the plane (1st plane vector) and a second direction in the plane (2nd plane vector) that is different from the first direction in the plane. The photon source and the photon detector can be arranged in a vertical direction relative to the first and second directions in the horizontal plane of the surface of the semiconductor substrate with respect to the first and second direction in the plane in the semiconductor substrate. This means that the photon source can be arranged between the surface and the photon detector. It would also be conceivable that the photon detector is located between the surface and the photon source. It is conceivable that the entropy source is part of a quantum process-based (random number) generator for true random numbers, which is configured to generate one or more random bits depending on an output signal from the entropy source.

A monolithically integrated entropy source can be understood as an entropy source whose photon source and photon detector are formed in a semiconductor substrate, optionally comprising one, two or more inseparably mutually connected layers.

An entropy source can be understood as a physical source of information whose output is random or non-deterministic. This can be achieved, among other things, by the entropy source comprising a non-deterministic photon source. Therefore, an entropy source is proposed the output signal of which is not deterministic.

It is conceivable that the entropy source whose output signal is not deterministic is understood to be an entropy source that fulfills the (approximately fifteen statistical) tests listed by the National Institute of Standards and Technology (NIST) in its guideline NIST SP 800-22 Rev. 1 of April 2010. The test can be used to determine whether an entropy source and/or a random number generator comprising the entropy source has a sufficient degree of entropy (or not), i.e., whether it is non-deterministic.

A photon source can be understood as a physical unit that is designed to emit photons during its operation.

A non-deterministic photon source can be understood as a photon source for which a prediction about the time at which it emits one (or more) photon(s) is not possible or is not exactly predictable. In other words, the exact time at which photons are emitted is random. However, it is conceivable that a probability regarding a number of photons emitted over a predetermined period, e.g., depending on environmental influences (such as temperature), can be estimated.

A photon detector can be understood as a physical unit that is designed to detect, in a measurable manner, photons during its operation.

The outer shell of the photon detector or photon source can be understood as those (surface) surfaces which are in contact with an environment of the photon detector or photon source, e.g. the semiconductor substrate.

The photon detector and/or the photon source can have a substantially cylindrical shape. A cylinder has a round base surface and a round top surface, which are arranged opposite each other. The side or lateral surface extends along the entire height of the cylinder and therefore connects the top and base surfaces in such a way that a closed body is created. The height of the cylinder corresponds to a (perpendicular) distance between the top surface and the base surface. The radius of the base surface can be larger than the height of the cylinder.

The photon detector and/or the photon source can have a substantially cuboid shape. A cuboid has a rectangular base surface and a rectangular top surface, which are arranged opposite each other. The lateral surface is formed of a plurality of precisely four, side surfaces and extends along the entire height of the cuboid and therefore connects the top and base surfaces in such a way that a closed body is created. The height of the cuboid corresponds to a (perpendicular) distance between the top surface and the base surface. The diagonal of the base surface can be larger than the height of the cuboid.

The photon source can be designed to emit photons through its base surface. The photon detector can be designed to detect photons striking its base surface.

As explained above, the base surface of the photon source can face the photon detector. This means that, regardless of the three-dimensional shape of the photon source, the base surface of the photon source can substantially be formed in a two-dimensional plane, with a normal vector perpendicular to the plane and thus to the base surface pointing in the direction of the photon detector. In the case of a cuboid photon source, the base surface can be the surface of the photon source that has the largest area and, after the top surface, the second largest area.

As explained above, the base surface of the photon detector can face the photon source. This means that, regardless of the three-dimensional shape of the photon detector, the base surface of the photon detector can substantially be formed in a two-dimensional plane, with a normal vector perpendicular to the plane and thus to the base surface pointing in the direction of the photon source. In the case of a cuboid photon source, the base surface can be the surface of the photon source that has the largest area and, after the top surface, the second largest area.

This also allows the two base surfaces to be arranged facing each other.

The design of the entropy source, according to which the base surfaces of the photon source are arranged facing the photon detector, offers the advantage that the photons emitted via the base surface of the photon source are emitted in the direction of the photon source, therefore hit the photon detector with a high probability and are in turn detected by it.

The design of the entropy source, according to which the base surfaces of the photon detector are arranged facing the photon source, offers the advantage that the photons emitted by the photon source hit the photon detector with a high probability, in particular the base surface of the photon detector and are in turn detected by it.

If the two base surfaces are arranged facing each other, the two effects described above occur in combination.

In any case, this allows a high number of the emitted photons to be detected by the photon detector, and thus a high entropy of the output signal of the entropy source can be achieved.

The photon source can be a single-photon source.

A single-photon source can be a light source or photon source that substantially never emits two or more photons simultaneously. It is also conceivable that the single-photon source is a photon source that emits only a few photons at a time.

The photon source can be an avalanche Zener diode. The avalanche Zener diode can have a breakdown voltage of less than or equal to 10 V, optionally a breakdown voltage of less than or equal to 8 V, and further optionally a breakdown voltage of less than or equal to 7 V. Avalanche Zener diodes allow a high single-photon rate at relatively low operating voltage (even below and in the range of the (Zener) breakdown voltage). Avalanche Zener diodes also allow for a construction or can be designed in such a way that the photons emitted by the photon source are highly likely to be emitted via the base surface of the photon source, since this has a larger area than the side surfaces.

The photon detector can comprise a single-photon detector, optionally a single photon avalanche diode (SPAD).

A single-photon detector can be understood as a detector that is designed to individually capture or detect photons individually emitted by the single-photon source.

The single-photon avalanche diode can include a first p-n junction formed from a first p-layer and a first n-layer, with the first p-layer and the first n-layer in contact with each other.

The p-layer and the n-layer can each be obtained by doping. In semiconductor technology, doping refers to the introduction of foreign atoms into a layer or into the base material of an integrated circuit. In a p-doped substrate (p for the free-moving positive vacancy), trivalent elements, the so-called acceptors, can be incorporated into a silicon lattice and replace tetravalent silicon atoms. In contrast, in n-type doping (n for the freely moving negative charge), pentavalent elements, known as donors, can be introduced into the silicon lattice and replace the tetravalent silicon atoms.

The single-photon avalanche diode may comprise an absorption region that is configured and arranged to absorb the photons emitted by the photon source in such a way that the absorption region generates one electron-hole pair per photon, optionally exactly. The absorption region may be in contact with the first p-n junction, and the first p-n junction may be designed to generate a charge avalanche due to the electron-hole pair generated. The photon detector can be configured to detect, based on the generated charge avalanche, the respective photon emitted by the photon source.

This means that if the single-photon avalanche diode is excited by single photons, an electron-hole pair can be generated in a sensorily active region or absorption region for each exciting photon (optionally each), wherein the excited electrons are drawn to a cathode by electric fields and the excited holes to an anode. In a single-photon avalanche diode, the charge carriers can drift through a so-called avalanche region formed by the p-n junction, within which a charge avalanche is generated by impact ionization. The single-photon avalanche diode can therefore be highly sensitive photon receiver elements which, when activated by a photon, can provide a large amount of charge (approx. 10⁵-10⁶ electrons) with high temporal resolution.

The single-photon avalanche diode can be operated in Geiger mode above the breakdown voltage, wherein a single photon can be detected via the generated charge avalanche and subsequently registered as a single event. To reduce the dead time occurring during registration, active or passive suppression or quenching of further charge carrier amplification can be carried out immediately after the onset of avalanche formation.

An integrated circuit can be provided which, in addition to the single-photon avalanche diode, also includes a so-called single-photon counter device or single-photon counter (SPC). Instead of a direct output of a single detector pulse, an immediate statistical evaluation of the temporal distribution of the individual detected single-photon events can then be carried out.

The absorption region may comprise or consist of a p-doped substrate that completely covers a surface of the first p-n junction facing the photon source.

The absorption region may comprise a p-doped substrate which only partially covers a surface of the first p-n junction facing the photon source and forms a channel extending from this surface of the first p-n junction towards the photon source, which is laterally bounded by an n-doped substrate.

The absorption region may comprise or consist of an n-doped substrate that completely covers a surface of the first p-n junction facing the photon source.

The absorption region can be in contact with the photon source, optionally a p-doped substrate of the photon source.

The single-photon avalanche diode can include a second p-n junction formed from a second p-layer and the first n-layer, with the second p-layer and the first n-layer in contact with each other.

It is conceivable that the second p-n junction is used as an additional photon detector for monitoring for external attacks. The additional p-n junction can be used, for example, to detect photons introduced into the entropy source from outside or externally. This allows external attacks to be detected.

It is conceivable that the second p-n junction is located between the first p-n junction and a back side of the semiconductor substrate that is opposite the surface of the semiconductor substrate defined above. This allows, in particular, the detection of an attack from the back of the semiconductor substrate.

The entropy source can have a metal layer, optionally together with an internal silicide layer, with the metal layer shielding the entropy source from the outside.

The metal layer can be used for shielding against external photons (“shadowing”) and/or for increasing efficiency by reflecting back the photons generated by the associated photon source.

The entropy source can have at least two anodes for the photon source and the photon detector, which are conductively connected to each other via the metal layer.

The photon source and/or the photon detector, optionally the entropy source as a whole, can be rotationally symmetric along an axis that is perpendicular to the first and/or the second base surface.

It is conceivable that the axis is perpendicular to the surface of the semiconductor substrate defined above and/or the back side opposite it.

The entropy source can be designed using bipolar CMOS-DMOS technology (BCD technology) or manufactured according to BCD technology.

Bipolar CMOS technology (BiCMOS technology) is a manufacturing method in semiconductor technology that combines two originally separate circuit technologies, namely circuits made of bipolar transistors (BJTs) and CMOS logic gates (complementary metal-oxide semiconductors) based on metal-oxide-semiconductor field-effect transistors (MOSFETs), into a single integrated circuit.

BCD technology can allow for effective and optimized integration of a SPAD, optionally with a variety of other functional groups, such as digital and/or analog circuit components, particularly energy-efficient digital storage and switching elements, general power and driver electronics, as well as detector and sensor components.

The entropy source can comprise a substrate with a carrier substrate and an epitaxial layer, wherein the epitaxial layer can have the first p-n junction and the carrier substrate can have the second p-n junction.

It is conceivable that the epitaxial layer is an epitaxial layer that has grown onto the carrier substrate. The first p-n junction can be located in the epitaxial layer (e.g., introduced by diffusion of dopants introduced via the surface of the carrier substrate below the epitaxial layer), and it can be a deep-lying p-n junction.

The carrier substrate can be a p-substrate. However, n-substrates or intrinsic substrates can also be used. The (semiconductor) substrate material can be silicon. An example of a dopant for the formation of a p-region is boron. Phosphorus (P), arsenic (As) and/or antimony (Sb) can be used to form an n-region. In silicon, for example, boron diffuses significantly further as a dopant than the heavier donors (P, As or Sb). Furthermore, it can be observed that the generated n-regions are largely dominant due to the higher doses used, i.e., an n-region already doped with phosphorus can retain its existing conduction type even after the additional introduction of boron. To provide the deep p-n junctions, additional masking, lithography and epitaxy steps in the usual BCD process can sometimes be omitted.

The first and second dopants may exhibit different diffusion properties in the carrier substrate and/or in the epitaxial layer. The second dopant may exhibit higher mobility in the carrier substrate and/or in the epitaxial layer than the first dopant. The introduction of the first dopant and/or the second dopant can be done without a mask or via a mask method. For maskless application, a direct ion beam writing method can be used, for example. In a mask method, the material can be introduced using a previously provided mask, wherein the introduction is carried out, for example, via a chemical or physical deposition process or also by means of an ion beam writing process. It is conceivable that the first region or the second region completely overlaps the other region immediately after the introduction of the second dopant (in a top view of the surface of the carrier substrate defined above). The first region can be a (deep-lying) n-layer (NBL layer) and the second region a (deep-lying) p-layer (PBL layer).

A top and/or bottom surface of the substrate can be mirrored, at least in the region of the photon source and/or the photon detector, and/or include a light-blocking layer.

The substrate can have a combination of at least one element consisting of metal covers, sidewall contacts and vias on its surface and/or back or on its top and/or bottom.

The entropy source described above can offer the advantage, among others, that the entropy source (and optionally a quantum random number generator encompassing the entropy source) is protected against external attacks and exhibits high efficiency and low substrate losses. This entropy source can optionally comprise an arrangement of a Zener-avLED and a SPAD stacked on top of each other in a common semiconductor substrate, in order to provide a compact and secure entropy source.

A method for operating an entropy source described above can also be provided. The method includes emitting photons by means of the photon source, so that the photons leave the photon source via its first base surface in the direction of the photon detector, and/or receiving the photons emitted by means of the photon source at the second base surface of the photon detector.

Furthermore, a quantum random number generator can be provided. The quantum random number generator comprises the entropy source described above, and an electronic circuit designed to generate a random bit depending on an output signal of the entropy source, and optionally to output the generated random bit, wherein a characteristic of the output signal of the entropy source depends on a temporal frequency of the photons detected by the photon detector.

The generated random bit can be part of a random bit data stream. This means that the quantum random number generator can be designed to continuously generate random bits and optionally output them in the form of a random bit data stream. The random bit data stream can then be considered random if it passes the following NIST test: Smid, Elaine Barker, et al. “A statistical test suite for random and pseudorandom number generators for cryptographic applications.” (2010). Downloadable from https://www.researchgate.net/profile/Salam-Ismaeel/post/Is_there_any_program_or_software_to_check_strength_of cryptography_algorithm2/attachment/59d61de479197b807797be4a/AS%3A273823310516224%401442295972158/download/NIST.pdf

The NIST Test Suite software can be downloaded from the following URL (as of the application date): https://csrc.nist.gov/CSRC/media/Projects/Random-Bit-Generation/documents/sts-2_1_2.zip

The quantum random number generator may comprise a pseudo-random number generator which is designed to generate a digital output signal based on the output signal of the entropy source and a generator polynomial that is optionally predetermined or adjustable.

The quantum random number generator may include a random bit generation unit designed to generate the random bit based on the digital output signal of the pseudorandom number generator.

The random bit generation unit can generate the random bit by determining a first value and a second value of the digital output signal. The random bit generation unit can generate the random bit by setting a value of an output of the random bit generation unit to a first logical value when the first value of the digital output signal is smaller than the second value of the digital output signal and the difference between the first value of the digital output signal and the second value of the digital output signal is greater than a minimum difference. The random bit generation unit can generate the random bit by setting the value of the output of the random bit generation unit to a second logical value when the first value of the digital output signal is greater than the second value of the digital output signal and the difference between the first value of the digital output signal and the second value of the digital output signal is greater than the minimum difference.

The random bit generation unit may be configured to discard the first value of the digital output signal and the second value of the digital output signal of the digital signal if a difference between the first and second values is less than a predetermined minimum difference.

The quantum random number generator can include a monitoring unit or watchdog designed to monitor the output of the random bit generation unit. It is conceivable that the monitoring unit detects a malfunction of the quantum random number generator if the number of discarded values from the random bit generation unit exceeds a predetermined limit.

Furthermore, the disclosure relates to an integrated electronic circuit, wherein the circuit comprises the monolithically integrated entropy source and/or the quantum random number generator described above. The integrated electronic circuit can be a microelectronically integrated circuit.

A QFN package (Quad Flat No Leads Package) can be used to manufacture or produce the integrated electronic circuit described above.

The following describes optional further developments of the object.

The detector means can include acoustic detection means for detecting and evaluating a sound signal, optionally ultrasonic detection means for detecting and evaluating an ultrasonic signal.

The sound detection means can include speech detection means for capturing a user's speech information and speech recognition means coupled with the control means for recognizing the captured speech information.

The ultrasonic detection means can include environmental mapping detection means and environmental detection means for capturing information about the object's surroundings, and environmental detection means coupled with the control means for detecting the captured information from other objects in the object's surroundings.

The sound detection means can include at least one microphone array for localizing the position of a sound source.

The ultrasonic detection means may include at least one ultrasonic microphone array for localizing the position of an ultrasonic sound source and/or an ultrasonic reflecting controllable and/or self-steering object.

The detector means and sensor means can include those for detecting the behavior of a user and/or the behavior of another controllable and/or self-controlling object and/or environmental parameters.

The sensor means may include at least one touch sensor, one humidity sensor, one temperature sensor, one light sensor, one pressure sensor, one accelerometer, one electromagnetic field sensor, one velocity sensor, one conductivity sensor, one chemical sensor, one level sensor, one motion sensor and/or one radar sensor and/or one sensor for locating persons or objects.

The action means may include mechanical actuators whose effects correspond to the behavior of the controllable and/or self-controlling object as specified by the means of control.

The mechanical actuators can include motors for adjusting moving parts of the object.

The action means may include at least a vibration generator, a magnetic arrangement, a pneumatic or hydraulic arrangement, a display, a heating/cooling device, a device that changes its shape when an electrical voltage or current is applied, a device for generating a chemical reaction and/or a device for generating an odor.

The action means can include acoustic generation means for generating a sound signal, optionally an ultrasonic generation unit for generating an ultrasonic signal. The sound-generating devices can have a function for music synthesis. The sound-generating means can be designed in such a way that they produce the sound signal by decompression of acoustic data. The acoustic generation means can be designed in such a way that they produce the sound signal by MP3-decompression of acoustic data.

The sound-generating devices can include speech-generating devices for producing speech information. The speech generation devices can be designed in such a way that they generate speech information depending on control information of the control devices using speech synthesis and/or generate speech information depending on control information of the control devices using text/speech conversion (“text-to-speech”). Speech-generating devices can have a prosody function.

The object may include a digital signal processor arrangement for signal processing that communicates with the control means, which is optionally intended for sound signal processing and/or the function of the digital signal processor arrangement is integrated into the control means.

The object may have interface means for the electrical control of an external device.

The object may have an internal clock, optionally including a radio-controlled clock, optionally wherein the internal clock can be synchronized by a synchronization signal supplied externally to the controllable object.

The control means can be designed in such a way that it can set the clock and record the time currently displayed by the clock.

The control means can be designed in such a way that, upon detecting a specific time displayed by the clock, they control the action means in a predefined manner.

The controllable object can be designed in the form of a doll and/or a motor vehicle.

The motor vehicle can be a passenger car, in particular an automobile, or a commercial vehicle, such as a truck.

The vehicle can be automated. The motor vehicle may be designed to take over longitudinal and/or lateral guidance at least partially and/or at least temporarily by means of the control device during automated driving of the motor vehicle.

Automated driving can be implemented in such a way that the movement of the motor vehicle is (largely) autonomous. Automated driving can be controlled at least partially and/or temporarily by the control device.

It is conceivable that the motor vehicle actively intervenes in the lateral guidance of the vehicle through a driver assistance system, e.g. by adjusting the actual steering wheel position, and optionally passively, e.g. by displaying a turning instruction.

The motor vehicle can be a Level 0 autonomous vehicle, i.e., the driver takes over the dynamic driving task, even if support systems (e.g., ABS or ESP) are present.

The motor vehicle may be a Level 1 autonomous vehicle, i.e., it may have certain driver assistance systems that support the driver in operating the vehicle, such as adaptive cruise control (ACC).

The motor vehicle can be a Level 2 autonomous vehicle, i.e., so semi-automated that functions such as automatic parking, lane keeping or lateral guidance, general longitudinal guidance, acceleration and/or braking are taken over by driver assistance systems.

The motor vehicle can be a Level 3 autonomous vehicle, i.e., so conditionally automated that the driver does not have to continuously monitor the vehicle system. The vehicle independently performs functions such as activating the turn signal, changing lanes and/or keeping in lane. The driver can engage in other activities, but will be prompted by the system to take over driving duties within a reasonable warning period if necessary.

The motor vehicle can be a Level 4 autonomous vehicle, i.e., so highly automated that the vehicle's control is permanently taken over by the vehicle's system. If the system can no longer handle the driving tasks, the driver may be asked to take over.

The motor vehicle can be a Level 5 autonomous vehicle, i.e., so fully automated that the driver is not required to perform the driving task. Apart from setting the target and starting the system, no human intervention is required. The motor vehicle can function without a steering wheel and pedals.

The random number generated by the quantum random number generator can be used to control the automated driving of the motor vehicle.

The control means may include, optionally at least partially interchangeable, storage media for storing a control program for the control means.

The object may include receiving means communicating with the control means for receiving externally supplied control data, wherein the control data is such that it influences the function of the object.

The object may include decoding and decryption means for decoding and decrypting the externally supplied control data. The object may include encoding and/or encryption means for encoding and/or encrypting control data that is used to control the object or the means of action.

The externally supplied control data can be such that it influences the control program stored in the storage media and thus optionally the control of the action means of the controllable and/or self-controlling object.

The object may include communicating transmission means for sending feedback data relating to the state of the controllable and/or self-controlling object, which may optionally contain information about reactions of the user of the controllable and/or self-controlling object.

The features described herein and the features shown in the figures are not only disclosed in the explicitly described embodiments and combinations. Therefore, other technically possible combinations as well as the isolated features are also included in the disclosure. Optional embodiments and specific examples are described below with reference to the figures to illustrate the disclosure, without limiting the disclosure to the embodiments or examples described or shown in the figures.

The reference numerals are used consistently across the figures, i.e., the same reference numerals in the figures refer to the same or at least similar objects.

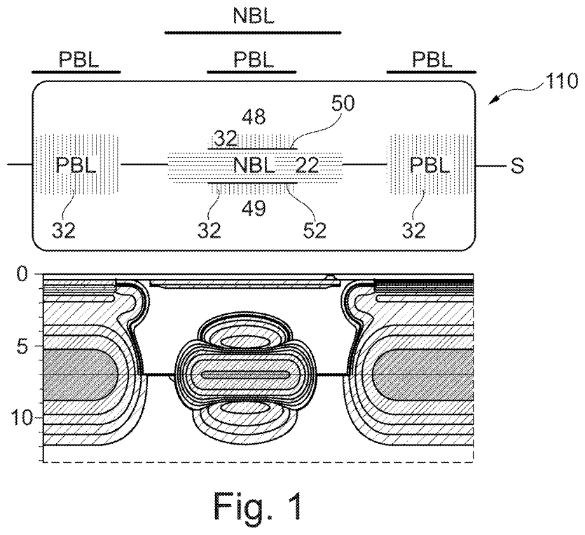

FIG. 1 shows a schematic representation of a (BCD) substrate 110 provided by a method for providing low-lying p-n junctions 50 and 52 in a BCD process and a TCAD representation of the resulting dopant distribution.

The method for generating low-lying p-n junctions 50 and 52 in a BCD process can include providing a carrier substrate 49.

The process can include introducing a first dopant to form a first region 22 (e.g. NBL) of the first conduction type (negative for NBL) into a surface S of the carrier substrate 49.

The method can include introducing a second dopant to form a second region 32 (e.g. PBL) of the second conduction type (positive for PBL) into the surface S of the carrier substrate 49, wherein the first region 22 (NBL) and the second region 32 (PBL) overlap at least partially.

The method can include growing an epitaxial layer 48 onto the surface S of the carrier substrate 49, wherein the first region 22 (NBL) and the second region 32 (PBL) spread through diffusion of the first dopant and the second dopant in the epitaxial layer 48 and thereby form a (first) p-n junction 50 located in the epitaxial layer 48.

In the illustration, the first region 22 is a deep-lying NBL layer and the second region 32 is a deep-lying PBL layer. However, the order is interchangeable, so that the first region 22 may also be a deep-lying PBL layer and the second region 32 may be a deep-lying NBL layer.

By appropriately adjusting the diffusion lengths of the individual dopants, the layer sequence of the p-n junctions 50 and 52 can also be reversed, e.g. the NBL and PBL layers at the p-n junctions 50 and 52 could also be swapped in FIG. 1.

The method can offer the advantage that the first region 22 (NBL) and the second region 32 (PBL) overlap at least partially. Optionally, immediately after introducing the second dopant, in a top view of the surface S of the carrier substrate 49, the first region 22 or the second region 32 may completely overlap the other region 32, 22. Therefore, in the embodiment shown, immediately after the introduction of the second dopant to form the second region 32 (PBL), this lies completely in the first region 22 (NBL) in a top view of the surface S of the carrier substrate 49. In order to form a p-n junction 50 located in the epitaxial layer, the first and the second dopant may have different diffusion properties in the carrier substrate 49 and/or in the epitaxial layer 48. Optionally, the second dopant in the second region 32 (PBL) can, as shown, exhibit a higher diffusion mobility (and thus diffusion length) in the carrier substrate 49 and in the epitaxial layer 48 than the first dopant in the first region 22 (NBL).

To enhance diffusion, the carrier substrate 49 can be heated after the introduction of the first dopant and/or the second dopant. After the epitaxial layer 48 has grown, the carrier substrate 49 can be heated to enhance dopant diffusion.

The introduction of the first dopant and/or the second dopant can be done without a mask or via a mask method in the proposed method. In the BCD wafer shown, a complete superposition of the first region 22 (NBL) with a single second region 32 (PBL) can be assumed. Traditionally, however, the first and second regions 22 and 32 are developed separately. In particular, their distance is generally chosen to be at least large enough to ensure that no overlapping regions are created even after the individual dopants have diffused out.

The TCAD representation shown below the schematic representation (Technology Computer-Aided Design, TCAD) illustrates an example of a dopant distribution within the contacted substrate 110 to simulate a corresponding integrated diode structure. Due to the double structure shown in this embodiment with an upper p-n junction 50 in the epitaxial layer 48 and a lower (second) p-n junction 52 in the carrier substrate 49, an effective constriction of the n-region (NBL) enclosed in the region of the p-n junctions 50 and 52 by the two p-regions (PBL) surrounding this n-region (NBL) is shown in the side view. Both p-n junctions 50, 52 can be configured to provide independent SPADs with a doping density and field strength distribution suitable for generating an avalanche effect.

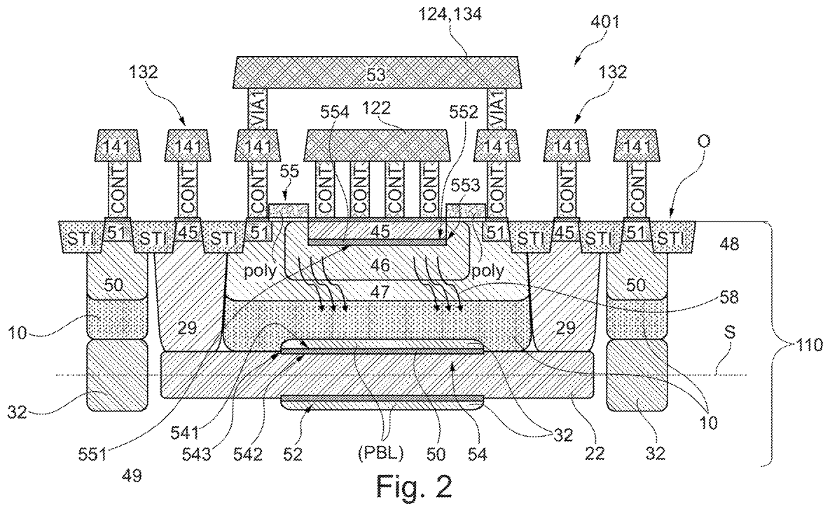

By using appropriate (semiconductor) substrates 110, which are suitable for use in BCD technologies, it is possible to create particularly deep SPADs (“deepSPADs”). There is still enough space above the provided SPADs to integrate further optoelectronic components. Therefore, a Zener-avLED formed above the deep-lying SPAD can be used to realize a particularly compact, vertically structured entropy source 401, in which individual photons 58 are optionally emitted vertically downwards by the Zener-avLED as photon sources 55 in the direction of the upper p-n junction 50 and are thus provided as a single-photon detector for detection by a SPAD formed as a photon detector 54 directly below the Zener-avLED at the upper p-n junction 50 (see FIGS. 2 to 4 with associated figure description).

FIG. 2 shows a schematic representation of an exemplary first embodiment of a (vertical) monolithically integrated entropy source 401.

The entropy source 401 may comprise a substrate 110 with a carrier substrate 49 and an epitaxial layer 48. The epitaxial layer 48 may have or comprise a first p-n junction 50 and/or a third p-n junction 554. The carrier substrate 49 can have or comprise a second p-n junction 52.

The entropy source 401 comprises a photon source 55, which is designed to emit photons 58. The photon source 55 includes a third p-n junction 554 formed from a third p-layer 46 and a third n-layer 45, wherein the third p-layer 46 and the third n-layer 45 are in contact with each other. The photon source 55, or more precisely its p-n junction 554, comprises a first outer shell, wherein the first outer shell is formed by a first base surface 551, a first top surface 552, and at least one first side surface 553 connecting the first base surface 551 and the first top surface 552. The first base surface 551 can have the same area as the first top surface 552. The first base surface 551 can have an area which is larger or smaller than the first top surface 552. A normal vector perpendicular to the first base surface 551 can be parallel to a normal vector perpendicular to the first top surface 552. The third p-n junction 554 can have a cylindrical shape. The height of the cylinder can be parallel to the normal vectors. The height of the cylinder can optionally be a multiple smaller than the radius of the first base surface 551 and/or the first top surface 552. The third p-n junction 554 may be a thin layer.

The entropy source 401 comprises a photon detector 54, which is designed to detect the photons 58 emitted by the photon source 55. For this purpose, the photon detector 54 comprises a first p-n junction 50 formed from a first p-layer 32 and a first n-layer 22, wherein the first p-layer 32 and the first n-layer 22 are in contact with each other. The photon detector 54, or more precisely its first p-n junction 50, comprises a second outer shell, wherein the second outer shell is formed by a second base surface 541, a second top surface 542, and at least one second side surface 543 connecting the second base surface 541 and the second top surface 542. The second base surface 541 can have the same area as the second top surface 542. The second base surface 541 can have an area which is larger or smaller than the first top surface 542. A normal vector standing perpendicular to the second base surface 541 can be parallel to a normal vector standing perpendicular to the second top surface 542. The first p-n junction 50 can have a cylindrical shape. The height of the cylinder can be parallel to the normal vectors. The height of the cylinder can optionally be a multiple smaller than the radius of the second base surface 541 and/or the second top surface 542. The first p-n junction 50 may be a thin layer.

The first base surface 541 of the third p-n junction 554 of the photon source 55 is arranged facing the second base surface 541 of the first p-n junction of the photon detector 55. This means that the normal vector standing perpendicular to the second base surface 541 is parallel to the normal vector standing perpendicular to the first base surface 551. The distance between the first base surface 551 and the second base surface 541 is shorter than the distance between the first top surface 552 and the second base surface 541.

The photon source 55 can be a silicon LED and/or a single photon source, optionally a SPAD or an avalanche Zener diode, wherein the avalanche Zener diode optionally has a breakdown voltage of less than 10 V.

The photon detector 55 comprises an absorption region 10, 47, which is designed and arranged to absorb the photons 58 emitted by the photon source 55 in such a way that the absorption region 10, 47 generates one electron-hole pair per photon 58, optionally exactly. The absorption region 10, 47 is in contact with the first p-n junction 50 (and the third p-n junction 554). The first p-n junction 50 is designed to generate a charge avalanche due to the generated electron-hole pair. The photon detector 54 is designed to detect the respective photon 58 emitted by the photon source 55 based on the generated charge avalanche.

The photon detector 54 can comprise a single-photon detector, optionally a single photon avalanche diode, optionally a SPAD.

However, the absorption region 10, 47 has or consists of a p-doped substrate that completely covers the surface, i.e. the second base surface 541 of the first p-n junction 50 facing the direction of the photon source 55.

The absorption region 10, 47 is in contact with the photon source 55, here the p-doped substrate 46 of the third p-n junction 554 of the photon source 55.

The photon detector 55 comprises a second p-n junction 52 formed from a second p-layer 32 and the first n-layer 22, wherein the second p-layer 32 and the first n-layer 22 are in contact with each other.

The entropy source 401 comprises a metal layer 53, optionally together with an internal silicide layer or a silicide layer facing a surface O, which shields the entropy source 401 towards the outside.

The entropy source 401 may comprise at least two anodes 124, 134 for the photon source 55 and the photon detector 54, which may be conductively connected to each other via the metal layer 53.

The photon source 55 and/or the photon detector 54, optionally the entropy source 401 as a whole, can be designed to be rotationally symmetrical along an axis. The axis can run parallel to the normal vectors described above, which are perpendicular to the first and/or the second base surface 541, 551 and/or perpendicular to the surface O.

Entropy source 401 can be produced using BCD technology.

An upper and/or lower surface of the entropy source 401 may be mirrored at least in the region of the photon source 55 and/or the photon detector 54 and/or comprise a light-blocking layer.

During operation of the entropy source 401, photons 58 can be emitted at random time intervals at the third p-n junction 554 of the photon source 55, so that the photons 58 leave the third p-n junction 554 of the photon source 55 via its first base surface 551 in the direction of the second base surface 541 of the first p-n junction of the photon detector 54, form an electron-hole pair in the absorption region 10, 47 and trigger a charge avalanche at the first p-n junction 50.

In detail, the vertical entropy source 401 can be characterized, in accordance with the document presented here, by a vertical arrangement of the photon source 55 relative to the photon detector 54. The horizontal is defined by the surface O of the semiconductor substrate 110 with the epitaxial layer 48. The connecting line of the centers of gravity of the vertical arrangement from the photon source 55 and the photon detector 54 is thus arranged vertically relative to the surface O of the substrate 49 with the epitaxial layer 48, where vertical here can be understood relatively softly as an angle of more than 30°, optimally 90° of this line relative to the surface O. The monolithically integrated entropy source 401 shown comprises the photon source 55 and the photon detector 54, wherein the photon source 55 and the photon detector 54 can be arranged vertically one above the other in a common substrate 110 made of a semiconductor material. Optionally, the photon source 55 is a single-photon source, which is set up to provide only one or a few photons 58 at a time (so-called single-photon source). Optionally, the photon source 55 is a light-emitting avalanche Zener diode (Zener-avLED) operated at an operating point below or near the breakdown voltage. Optionally, the photon detector 54 can be a single-photon detector, such as a single-photon avalanche diode.

The entropy source 401 can be formed in a (BCD) substrate 110 using BCD technology. The substrate 110 can comprise the carrier substrate 49 and the epitaxial layer 48 grown on the carrier substrate 49. The p-n junctions 50, 52 can be arranged as described with reference to FIG. 1. The photon detector 55 can include an avalanche region formed in a region around the upper p-n junction 50 of the photon detector 54 and an absorption region 10, 47 with a high-voltage p-type well 10 and a p-type well 47 for converting photons into electron-hole pairs, wherein the absorption region 10, 47 can be directly adjacent to the regions 22, 32 forming the low-lying p-n junction 50. The fully developed high-voltage p-type well 10 can thereby enable an optimal connection of the low-lying p-n junction 50 from the anode 124, 134.

The upper deep-lying p-n junction 50 of the photon detector 54 can be formed between a deep-lying n-layer 22, which serves or acts as a cathode 132, and a deep-lying p-layer 32 immediately adjoining the deep-lying n-layer 22. The absorption region 10, 47 can be directly adjacent to the deep-lying p-layer 32 and is substantially formed as a p-region (optionally including an intrinsic region). The anode 46 (p−) of the uppermost or third p-n junction 554 can be connected to a p+ region 51 via the p-region 47, while the anode 32 of the middle or second p-n junction 50 can also be connected to the p+ region 51 via the region 10 and the region 47.

In the illustrated exemplary embodiment, the respective anodes 124, 134 of the photon source 55 and the photon detector 54 are combined. These can then be electrically contacted, for example, via the common metallization 53 on the surface O of the substrate 110. A common and continuous metallization 53 can also provide shielding against electromagnetic waves from above. The associated cathodes 122, 132 are each individually designed as examples and can be electrically contacted via a first associated further metallization 141.

The entropy source 401 can be designed as a circular structure (corresponding to a spatial rotation of the shown representation plane around an imaginary central axis in the vertical direction). However, other formations of the entropy source 401 are also possible.

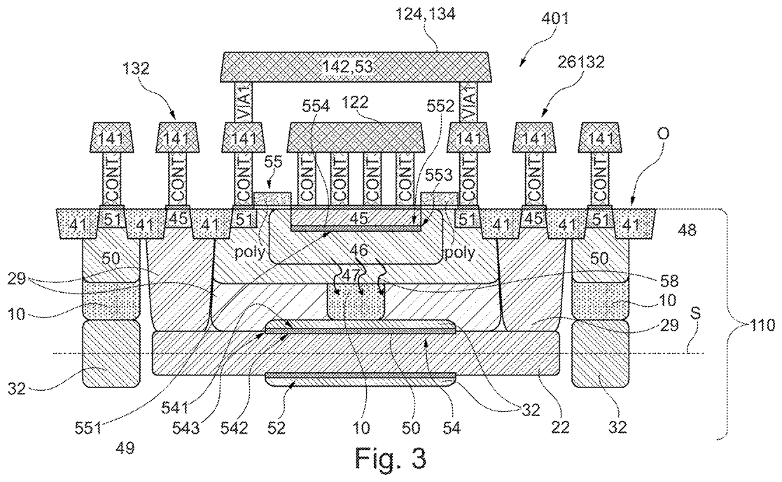

FIG. 3 shows a schematic representation of an exemplary second embodiment of the entropy source 401. The embodiment shown in FIG. 3 largely corresponds to the first embodiment shown in FIG. 2 and described above. The reference numerals and their respective assignment to individual features therefore apply accordingly.

In the second embodiment, the absorption region 10, 47, which comprises the p-doped substrate, is designed such that it only partially covers the surface or second base surface 541 of the first p-n junction 50 facing the photon source 55 and forms a channel extending from this second base surface 541 of the first p-n junction 50 in the direction of the photon source 55, which is laterally bounded by an n-doped substrate 29.

This means that, compared to the first embodiment, the high-voltage p-type well 10 is structurally tapered and an additional (weakly) n-doped region 29 is provided. The high-voltage p-type well 10 of the absorption region 10, 47 forms a channel between the upper p-type well 47, also shown in FIG. 2, and the (lower-lying) p-layer 32 of the second p-n junction 50. The region surrounding the channel is defined by the (weakly) n-doped region 29. Through the channel, the low-lying upper p-n junction 50 is electrically connected to the upper p-n junction 45, 46 without an additional penetration/punch through the n-doped region 29 and is irradiated with photons 58 by the photon source 54.

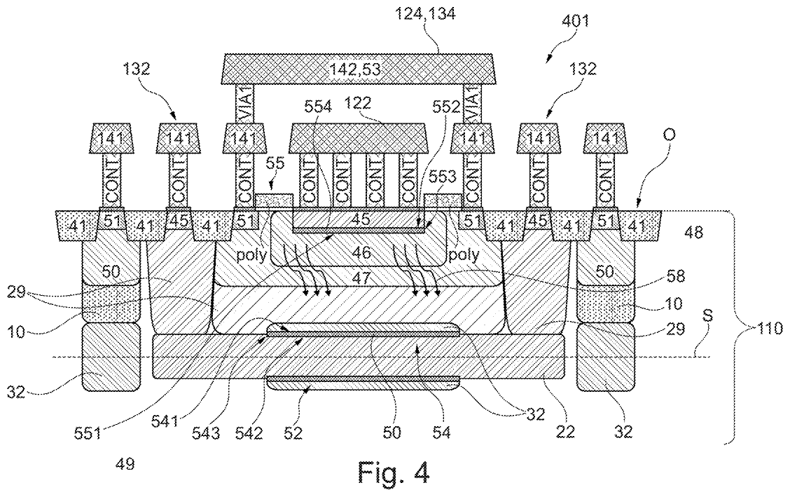

FIG. 4 shows a schematic representation of an exemplary third embodiment of the entropy source 401. The third embodiment shown largely corresponds to the first and second embodiment shown in FIGS. 2 and 3 and described above. The reference numerals and their respective assignment to individual characteristics therefore apply accordingly.

However, the absorption region 10, 47 has (or consists of) an n-doped substrate 29 that completely covers the base surface 541 of the first p-n junction 50 facing the direction of the photon source 55.

In comparison to the second embodiment, the third embodiment does not include a channel-shaped high-voltage p-type well 10 in the absorption region 10, 47. The weakly n-doped region 29 formed in the epitaxial layer 48 extends over the entire lower region between the second p-n junction 50 and the photon source 54. In this respect, compared to the second embodiment, the high-voltage p-type well 10 in this region has been structurally replaced by the (weakly) n-doped region 29. The low-lying upper p-n junction 50 is thus connected to the photon source 54 only after an additional punch through the weakly n-doped region 29, which causes a decoupling of possibly several parallel entropy sources 401.

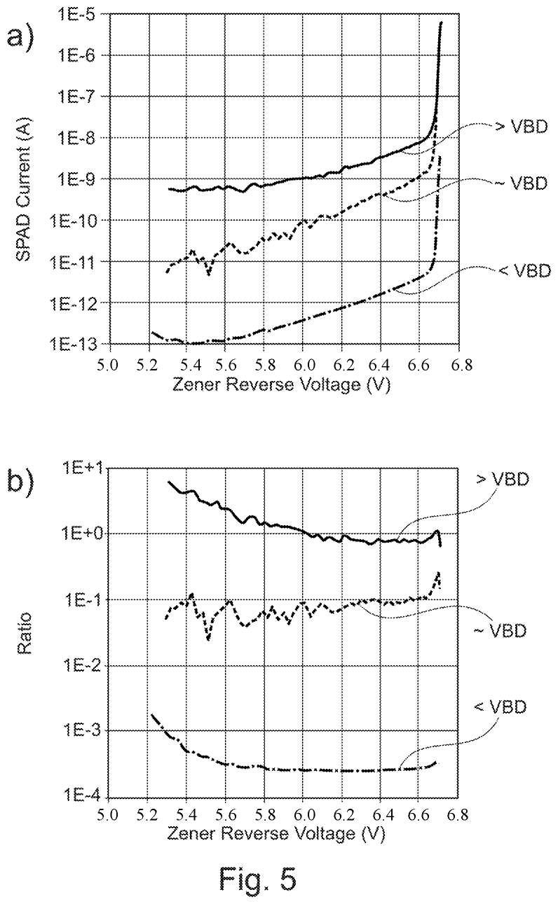

FIG. 5 shows a graphical representation of the dependence of a) the SPAD current and b) the ratio between SPAD current and Zener current as a function of the Zener reverse voltage at different SPAD reverse voltages (less than, equal to, greater than the breakdown voltage) within the entropy source 401. The dependency shown under a) clearly demonstrates that the SPAD current increases exponentially with the Zener reverse voltage in the range of 5.6 V to 6.6 V. This applies to all operating modes of the SPAD, i.e. below its own breakdown voltage (<VBD, linear range), near the breakdown voltage (~VBD, avalanche range) as well as above the breakdown voltage (>VBD) and thus also in Geiger operation.

The lower curve shown under b) (<VBD) shows that the measured current ratio between the SPAD current and the Zener current is approximately 1:4000 for various Zener reverse voltages in the range of 5.8 to 6.6 V. In the region of the breakdown voltage (~VBD) of the SPAD, the ratio increases to values around 1:10. This is due to the so-called multiplication factor of the SPAD, which leaves the linear range in the region of the breakdown voltage. The upper curve finally indicates the corresponding ratio for the SPAD operated above the associated breakdown voltage (>VBD) (approximately 1:1). This means that when a SPAD is operated above the associated breakdown voltage (>VBD), the generated photocurrent and the Zener current of the Zener-avLED are approximately equal, and a clear measurement signal can be obtained by coupling photons to the SPAD.

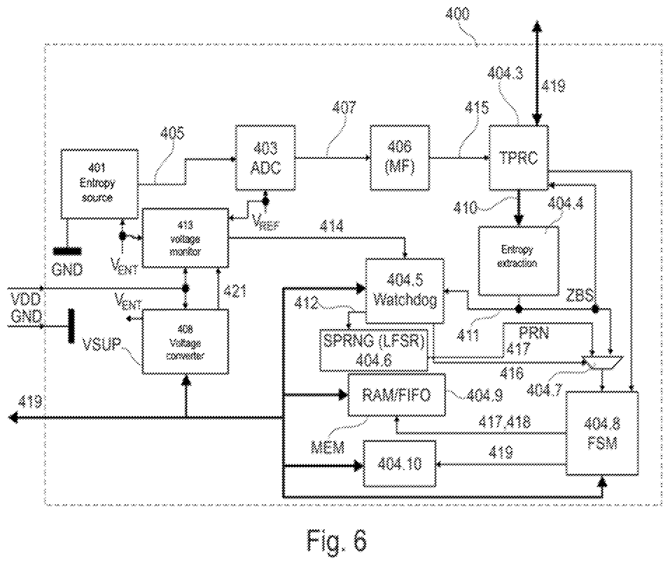

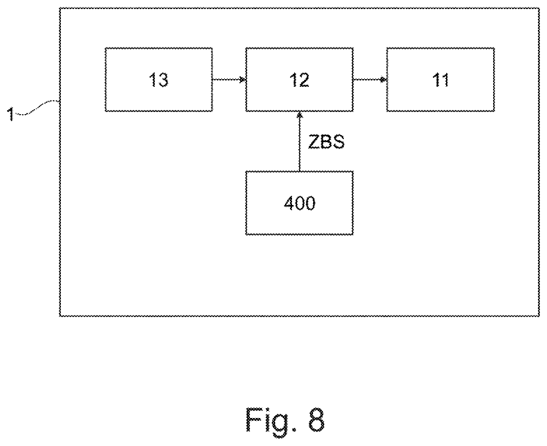

FIG. 6 shows a schematic representation of a quantum random number generator 400 for generating and outputting a digital random number sequence, e.g. in the form of a random bitstream ZBS (see also FIG. 8) and/or, optionally by means of a finite-state machine 404.8, a random bit data word 418.

The quantum random number generator 400 is described in more detail below.

The quantum random number generator 400 includes the entropy source 401 described above. The entropy source 401 of the quantum random number generator 400 can be supplied with a voltage via a supply voltage line V_{ENT}, which can be connected to a voltage converter 408, relative to a reference potential on a reference potential line GND.

An output signal or voltage signal 405 generated by the entropy source 401 can first be digitized in an analog-to-digital converter (ADC) 403, which can optionally be supplied via a reference voltage line V_{REF}, and then passed as a digital output signal 407 to a pulse extension circuit 406.

The output signal 405 of the entropy source 401 can be obtained, for example, by positively biasing the region 45 relative to the region 51 (via breakdown voltage). This enables the third p-n junction 554 to emit the photons 58. The region 22 is positively biased relative to region 32 (in the reverse direction). If the third p-n junction 554 emits a photon 58 and this photon 58 is detected by the second p-n junction 50, then a current pulse can be tapped at the cathode 132, which in turn can be converted into a voltage pulse. This voltage pulse can correspond to the output signal 405 of the entropy source 401.

The supply voltage line V_{ENT} and/or the reference voltage line V_{REF} can be monitored via a voltage monitor 413, wherein the voltage converter 408 and/or the voltage monitor 413 can be supplied with voltage via a positive supply voltage line VDD relative to the reference potential on the reference potential line GND. The voltage converter 408 can be connected to the voltage monitor 413 via a voltage converter line 421.

The pulse extension circuit 406 can be a monostable multivibrator (monoflop, MF). The monostable multivibrator can be used to extend a pulse on the line of the digital output signal 407 of the ADC 403 depending on a certain predetermined system clock, for example to a time length of at least one clock period of the system clock.

The pulse extension circuit 406 can output a synchronized voltage signal 415, i.e., for example, a pulse with a certain minimum length, and optionally pass it to a pseudorandom number generator 404.3.

The pseudorandom number generator 404.3 may be a time-to-pseudo-random number converter (TPRC). It can be structured in one or more stages. For example, the TPRC can include an analog instrument, a time-to-analog converter (TAC), and/or an analog-to-pseudo-random number converter (APRC). The TPRC can include a feedback shift register which, depending on its design, shifts its values one position to the left or right with each clock cycle of the system clock and feeds the feedback value of a predefined feedback polynomial back into the freed bit. The feedback polynomial can be a simple, primitive feedback polynomial. One advantage of such a TPRC is its speed and small chip area, as well as the fact that an attacker can hardly measure its success. Instead of the TPRC, a time-to-digital converter (TDC) can also be used, which is typically a binary start-stop counter that is started with a first pulse of the synchronized voltage signal 415 and stopped with a second pulse of the synchronized voltage signal 415. The pseudorandom number generator 404.3 can be (optionally directly) connected to an internal data bus 419. An output signal 410 of the pseudorandom number generator 404.3 can be fed to an entropy extraction 404.4.

To generate the output signal 410 of the pseudorandom number generator 404.3, starting with a starting value (a so called seed value) of the pseudorandom number generator 404.3, exactly one pseudorandom number from the pseudorandom number generator 404.3 can be assigned (bijectively) to each clock cycle of the system clock after a falling edge of the synchronized voltage signal 415, i.e., the value of the pseudorandom number can then be used to determine the time position of the relevant clock cycle of the system clock after the falling edge of the synchronized voltage signal 415.

Therefore, a pseudorandom number generator 404.3 can be used. One advantage of this is that even if an attacker successfully induces a disturbance in the synchronized voltage signal 415, the randomness of the quantum random bit at the output 411 of the entropy extraction 404.4 is only marginally disturbed, since the attacker would have to know the associated feedback polynomial of the pseudorandom number generator 404.3. The feedback polynomial can, for example, be randomly selected from a large number of possibilities. The same applies to the seed value of the pseudorandom number generator 404.3, which an attacker would also have to determine. Another advantage of a pseudorandom number generator 404.3 instead of a simple digital counter is the smaller space requirement of the feedback logic using a simple primitive feedback polynomial compared to a binary counter. If the linearly feedback shift register of the pseudorandom number generator is long enough, then each clock cycle between two pulses of the voltage signal 405 generated by the entropy source 401 is typically assigned a unique pseudorandom number.

The entropy extraction 404.4 can be used to detect an error (i.e. an undesired state) in the output signal 410 of the pseudorandom number generator 404.3. For this purpose, the entropy extraction 404.4 can have two linearly feedback-controlled shift registers that are comparable to each other via a comparator. Therefore, conventional binary counters can be dispensed with here as well. Depending on the register depth, feedback can also be provided via simple primitive polynomials as generator polynomials or feedback polynomials. The length of the linearly feedback-controlled shift registers can be freely adjusted. Long shift registers generally exhibit good random statistics or random distribution. Shorter shift registers allow for a high data rate. Using shift registers at this point can have the advantage that few gates are needed, the logic depth of the circuits can be small, and thus the clock rate can be high. This reduces the probability of two identical numbers occurring and increases the random bit rate.

A corresponding method for entropy extraction can provide that two values of the output signal 410 of the pseudorandom number generator 404.3 are first determined and stored in shift registers of the entropy extraction 404.4. If two values are stored in the shift register of the entropy extraction 404.4, the entropy extraction 404.4 can compare these two values. The values in the shift registers of the entropy extraction 404.4 thus comprise a first value and a second value, both of which were determined by the pseudorandom number generator 404.3. Entropy extraction 404.4 can then evaluate the two values. If the first value is smaller than the second value and the difference between the first value and the second value is greater than a minimum difference F, then the entropy extraction 404.4 can set the value of its output 411 to a first logical value. If the first value is greater than the second value and the difference between the first value and the second value is greater than the minimum difference F, then the entropy extraction 404.4 can set its output 411 to a second logical value, which is different from the first logical value. If the difference between the first value and the second value is smaller than the minimum difference F, entropy extraction 404.4 can discard the first value and the second value. The entropy extraction 404.4 can cause a so-called watchdog 404.5 to increase an error counter by a first error counter step size in such a case. The first error counter increment can be negative. Conversely, the entropy extraction 404.4 can decrease the error counter of the watchdog 404.5 by a second error counter step size if the difference between the first value and the second value is greater than the minimum difference F. The second error counter step size can be the same as the first error counter step size. The respective logical value (e.g. 0 or 1) to which the entropy extraction 404.4 sets its output 411 corresponds to a random number. Since the entropy extraction 404.4 continuously outputs random numbers via its output, a random number stream ZBS is created. This random number stream ZBS can be used for an object 1, as described in more detail later.

The watchdog 404.5 can be connected to the internal data bus 419 as a transport means for the random bit stream ZBS. The internal data bus 419 can, for example, be connected to an object 1 and/or one or more memories and/or one or more CPUs (see also the description of FIG. 8). The watchdog 404.5 can be connected to the voltage monitor 413 via one or more optional digital input/output signal lines 414. The watchdog 404.5 can monitor voltage values determined by the voltage monitor 413. The voltage monitor 413 can be configured to detect and/or monitor one or more voltages in the quantum random number generator 400, and optionally also one or more voltages within a respective application circuit, such as the object 1 and/or a system 1000. The voltage monitor 413, for example, could be an ADC.

One task of the watchdog 404.5 can be to monitor the entropy quality of the random numbers at output 411 of the entropy extraction 404.4, which form the random bit stream ZBS. The watchdog 404.5 can be designed to detect at least three defined error cases. The watchdog 404.5 can transmit valid quantum random bits 411, generating a seed value S, via a line 412 to a (backup) pseudo random number generator (English: “Pseudo Random Number Generator, PRNG”) 404.6, which may have another linearly feedback shift register. The watchdog 404.5 can prevent the use of valid quantum random bits by a finite-state machine 404.8. This is shown here as an example connected to the internal data bus 419. If an error occurs, the watchdog 404.5 can set certain error bits for further evaluation, which another bus participant (e.g. a microcontroller (MCU)) can read and/or write via an external data bus DB, a data bus interface DBIF and the internal data bus 419.

For example, if the watchdog 404.5 detects a fault in the quantum random number generator 400, it can put the quantum random number generator 400 into an emergency operating state. For this purpose, the watchdog 404.5 can, for example, set a selection signal 416 of a signal multiplexer 404.7 downstream of the random number generation such that the signal multiplexer 404.7 sends the pseudorandom number PRN of the optional PRNG 404.6, in the form of a stream of pseudorandom bits, via a pseudorandom signal line 417 to the input of the finite-state machine 404.8 instead of the random numbers RN at the output 411 of the entropy extraction 404.4 as a replacement for the at least potentially faulty random number RN of output 411 of entropy extraction 404.4.

The optional additional linear feedback shift register of the PRNG 404.6 can be configured to generate pseudorandom numbers PRN. The seed value S can contain the last valid quantum random bits of output 411 from entropy extraction 404.4. The watchdog 404.5 can then apply or output these last valid quantum random bits 411 to the input of the optional PRNG 404.6. The seed value S can thus be used as a random, safe starting value for a generator polynomial of the feedback of the optional further linearly feedback shift register of the PRNG 404.6 for the generation of the pseudorandom number PRN and its signaling via the pseudorandom signal line 417. The generator polynomial and the degree of the generator polynomial can be freely chosen. The optional backup pseudorandom number generator 404.6 allows for the provision of secure random numbers, at least temporarily, in case of an error.

The finite-state machine 404.8 can be equipped to receive the random numbers forming the random bit stream ZBS or optionally the pseudorandom number PRN (optionally at the output of the signal multiplexer 404.7) and, based on this, to generate at least one quantum random data word 418. Optionally, via a pseudorandom signal line 417, the quantum random data word 418 can be written from the finite-state machine 404.8 into a memory 404.9, optionally a volatile memory (RAM) or a FIFO memory (First In-First Out). It is conceivable that the finite-state machine 404.8 sets a finish flag 404.10 via the internal data bus 419 as soon as the quantum random data word 418 is written into memory 404.9. A processor (MCU) can then, for example, access memory 404.9 and read the quantum random data word 418 and use it, for example, for encryption. This means that, in addition to or as an alternative to the random bit data stream ZBS, the object 1 (see FIG. 8) also can use the quantum random data word 418 for encryption. The description below, referring to the random bit data stream ZBS, therefore applies analogously to the quantum random data word 418.

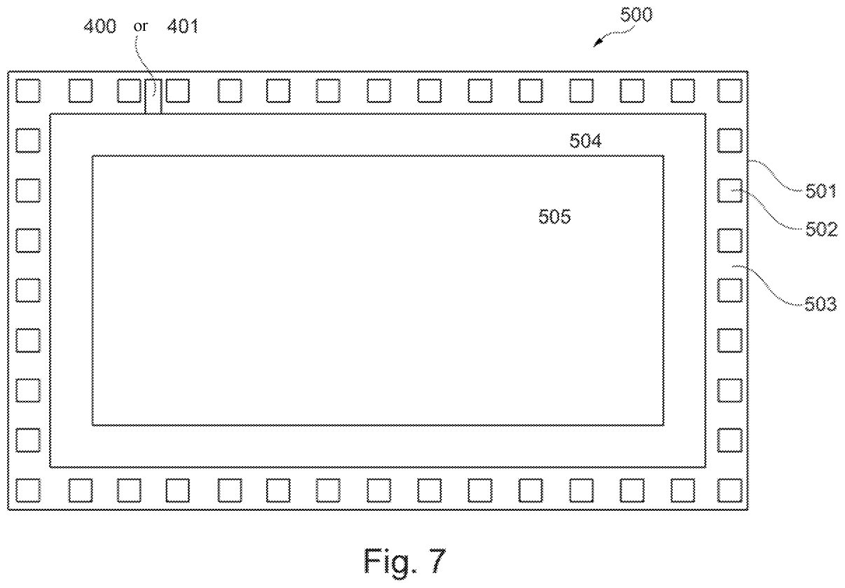

FIG. 7 shows a schematic representation of an exemplary layout of an integrated electronic circuit 500 with the quantum random number generator 400 with the entropy source 401 in a pad frame 503 in a top view.

The integrated electronic circuit 500, for example a microcontroller with a CPU, may have an inner region 505. The inner region 505 may contain sub-circuits of the integrated electronic circuit 500.

The inner region 505 can be surrounded by a wiring region 504. In the wiring region 504, supply voltage lines, data bus lines and/or other lines may be routed or located.

The wiring region 504 and the inner region 505 of the integrated electronic circuit 500 can be surrounded by a pad frame 503 (also called pad edge). The pad frame 503 can include connection pads 502 (connection surfaces) (optional for electrical bond connections and/or other electrical connection connections).

The entropy source 401 and/or the quantum random number generator 400 can be arranged wholly or at least in essential parts within the pad frame 503, more precisely between at least two connection pads 502. This may be possible because gaps between the individual connection pads 502 cannot be filled with electronic circuit components. However, these gaps still need to be processed during the manufacturing of the integrated electronic circuit 500 and can therefore cause manufacturing costs. Placing the entropy source 401 and/or the quantum random number generator 400 entirely or at least in substantial part within the pad frame 503 can therefore reduce the additional costs for their provision.

At least the photon source 55 and/or the photon detector 54 can be placed or arranged in the pad frame 503 (optionally between two connection pads 502). Furthermore, the ADC 403, the voltage converter 408 for supplying energy to the entropy source 401, the pulse extension circuit 406 and/or other analog components of the quantum random number generator 400 can be placed in the pad frame 503 (optionally between two connection pads 502).

FIG. 8 shows a schematic representation of a controllable and/or self-controlling object 1. The object 1 comprises action means 11 for generating a specific behavior of the object 1, control means 12 for controlling the action means 11 in accordance with corresponding control information, and detector means 13 for detecting environmental influences acting on the object 1. Object 1 also includes, at least partially, the quantum random number generator described above. The control means 12 are designed to control the action means 11 depending on the environmental influences detected by the detector means 13 and depending on the random bit or random bit stream ZBS.

The action means 11, the control means 12 and/or the detector means 13 may be part of or constitute a driver assistance system of a motor vehicle.

The control means 12 can be designed as a control device or control unit. The control means 12 could, for example, be an electronic control unit (ECU). The electronic control unit can be an intelligent processor-controlled unit that can communicate with other modules via a Central Gateway (CGW) and can form the vehicle's on-board network via fieldbuses such as the CAN bus, LIN bus, MOST bus, FlexRay and/or the Automotive Ethernet, e.g. together with telematics control units and/or environmental sensors.

The action means 11 can be designed to influence the driving behavior of a motor vehicle, e.g. an automobile, based on or depending on the control information. This can include positive and/or negative acceleration of the motor vehicle (so-called longitudinal guidance). This may, additionally or alternatively, include adjusting the direction of travel of the motor vehicle (so-called lateral guidance). Insofar as controlling is mentioned here, this can also include or represent rules, i.e., controlling with a feedback variable.

It is therefore conceivable that the control means 12 control functions relevant to the driving behavior of the motor vehicle, such as the steering, the engine control, the power transmission, and/or the braking system. Furthermore, driver assistance systems, such as a parking assistant (optionally including an ultrasonic sensor, which is part of the detector means 13), an adapted speed control (ACC, English: Adaptive Cruise Control), a lane keeping assistant, a lane change assistant, a traffic sign recognition, a light signal recognition, a hill start assistant, a night vision assistant and/or a junction assistant, can be controlled by the control unit.

The control of the motor vehicle by the control means, i.e. the generation of the control information which then results in the control of the driving behavior of the motor vehicle by the action means 11, can be carried out depending on the random bit generated by the quantum random number generator or the random bit stream ZBS.

The detector means 13 can include a radar sensor, a LiDAR sensor, an ultrasonic sensor, an infrared sensor and/or a camera.

LIST OF REFERENCE CHARACTERS

| | |
|---|---|
| 1 | object |
| 11 | action means |
| 12 | control means |
| 13 | detector means |
| 10 | p-doped substrate |
| 29 | n region (HVNW/NEPI) |
| 22 | first region (e.g. NBL) |
| 32 | second region (e.g. PBL) |
| 45 | n+ region (N+) |
| 46 | p+ region (PBODY) |
| 47 | absorption region |
| 48 | epitaxial layer |
| 49 | carrier substrate |
| 51 | p+ region (P+) |
| 50 | first p-n junction |
| 52 | second p-n junction |
| 53 | metallization or metal layer |
| 54 | photon detector |
| 541 | base surface |
| 542 | top surface |
| 543 | side surface/lateral surface |
| 55 | photon source |
| 551 | base surface |
| 552 | top surface |
| 553 | side surface/lateral surface |
| 554 | third p-n junction |
| 58 | photon(s) |
| 110 | substrate |
| 122 | cathode photon source |
| 132 | cathode photon detector |
| 124, 134 | anode |
| 141 | metallization |
| 142 | metallization |
| 400 | quantum random number generator |
| 401 | entropy source |
| 403 | analog-to-digital converter |
| 404.3 | pseudo random number generator |
| 404.4 | entropy extraction or filter module |
| 404.6 | (backup) pseudo random number generators |
| 404.7 | signal multiplexer |
| 404.8 | finite-state machine |
| 404.9 | memory |
| 404.10 | finish flag |
| 405 | output signal entropy source |
| 406 | pulse extension circuit |
| 407 | output signal analog-to-digital converter |
| 408 | voltage converter |
| 410 | output signal of the pseudo random number generator |
| 411 | output entropy extraction or filter module |
| 412 | line watchdog/(backup) pseudo random number generators |
| 413 | voltage monitor |
| 414 | input/output signal lines |
| 415 | synchronized voltage signal |
| 416 | selection signal |
| 418 | quantum random data word |
| 419 | internal data bus |
| 421 | voltage converter line |
| 500 | integrated electronic circuit |
| 501 | frame/outer edge |
| 502 | connection pad |
| 503 | pad frame |
| 504 | wiring region |
| 505 | inner region |
| VDD | supply voltage line |
| V_{ENT} | supply voltage line |
| V_{REF} | reference voltage line |
| GND | reference potential line |
| ZBS | random bit (data) stream |
| O | surface of the substrate |
| S | surface of the carrier substrate |

What is claimed is:

1. A controllable and/or self-controlling object, comprising:
an action unit for producing a specific behavior of the object,
a control unit to control the action unit in accordance with corresponding control information,
a detector unit for detecting environmental influences acting on the object,
a quantum random number generator, wherein the quantum random number generator includes a monolithically integrated entropy source, wherein the entropy source includes a photon source configured to emit photons, wherein the photon source includes an outer shell, wherein the outer shell is formed by a base surface, a top surface and at least one side surface connecting the base surface and the top surface, and a photon detector designed to detect the photons emitted by the photon source, wherein the base surface of the photon source is arranged facing the photon detector, wherein the base surface of the photon source is formed in a two dimensional plane, wherein a normal vector perpendicular to the base surface is pointed in a direction of the photon detector, and
an electronic circuit designed to generate a random bit depending on an output signal of the entropy source, wherein a characteristic of the output signal of the entropy source depends on a temporal frequency of the photons detected by the photon detector, and
wherein the control unit is designed to control the action unit depending on the environmental influences detected by the detector unit and depending on the random bit.

2. The object according to claim 1, wherein the photon source includes at least one of a silicon LED and a single photon source.

3. The object according to claim 1, wherein the photon source includes a p-n junction formed from a p-layer and an n-layer.

4. The object according to claim 1, wherein the photon detector includes a single photon detector.

5. The object according to claim 1, wherein the photon detector includes a p-n junction formed from a p-layer and a layer.

6. The object according to claim 5, wherein the photon detector includes:
an absorption region designed and arranged to absorb the photons emitted by the photon source in such a way that the absorption region generates one electron-hole pair per photon,
wherein the absorption region is in contact with the p-n junction and the p-n junction is designed to generate a charge avalanche due to the generated electron-hole pair, and
the photon detector is designed to detect the respective photon emitted by the photon source based on the generated charge avalanche.

7. The object according to claim 6, wherein the absorption region includes a p-doped substrate that completely covers a surface of the p-n junction facing towards the photon source.

8. The object according to claim 6, wherein the absorption region includes a p-doped substrate which only partially covers a surface of the p-n junction facing towards the photon source and forms a channel extending from said surface of the p-n junction towards the photon source, which is laterally bounded by an n-doped substrate.

9. The object according to claim 6, wherein the absorption region includes an n-doped substrate that completely covers a surface of the p-n junction facing towards the photon source.

10. The object according to claim 6, wherein the absorption region is in contact with the photon source.

11. The object according to claim 5, wherein the photon detector includes a further p-n junction formed from a further p-layer, and a further n-layer or the n-layer.

12. The object according to claim 1, wherein the entropy source includes a metal layer which shields the entropy source from a surrounding.

13. The object according to claim 12, wherein the entropy source includes at least two anodes for the photon source and the photon detector which are conductively connected to each other via the metal layer.

14. The object according to claim 1, wherein at least one of the photon source and the photon detector is designed rotationally symmetric along an axis that is perpendicular to the base surface.

15. The object according to claim 1, wherein the entropy source is manufactured using BCD technology.

16. The object according to claim 1, wherein the entropy source includes a substrate with a carrier substrate and an epitaxial layer.

17. The object according to claim 1, wherein at least one of a top surface and a bottom surface of the entropy source is mirrored and/or includes a light-blocking layer at least in an area of the photon source and/or the photon detector.

18. The object according to claim 1, wherein the quantum random number generator includes a pseudorandom number generator configured to generate a digital output signal based on the output signal of the entropy source.

19. The object according to claim 18, wherein the quantum random number generator includes an entropy extraction unit configured to generate the random bit based on the digital output signal of the pseudorandom number generator.

20. The object according to claim 19, wherein the entropy extraction unit is configured to generate the random bit by:
determining a first value and a second value of the digital output signal,
setting a value of an output of the random bit generation unit to a first logical value if the first value of the digital output signal is less than the second value of the digital output signal and a difference between the first value of the digital output signal and the second value of the digital output signal is greater than a minimum difference, and
setting the value of the output of the quantum random number generator to a second logical value if the first value of the digital output signal is greater than the second value of the digital output signal and the difference between the first value of the digital output signal and the second value of the digital output signal is greater than the minimum difference.

21. The object according to claim 20, wherein the random bit generation unit is configured to discard the first value of the digital output signal and the second value of the digital output signal of the digital signal if the difference between the first and the second value is less than the minimum difference.

22. The object according to claim 20, wherein that the quantum random number generator includes a monitoring unit configured to monitor the output of the quantum random number generator.

23. A method for operating the object according to claim 1, comprising:
emitting the photons from the photon source such that the photons leave the photon source via its base surface in the direction of the photon detector, and
receiving the photons emitted by the photon source at a base surface of the photon detector.
